(19) United States
(12) Patent Application Publication
(10) Pub. No.: US 2024/0343140 A1
(43) Pub. Date: Oct. 17, 2024

(54) METHOD AND APPARATUS TO CHARGE EXTRA LOW VOLTAGE BATTERIES

(71) Applicant: Lester Electrical of Nebraska, Inc., Lincoln, NE (US)

(72) Inventors: Spencer Stock, Lincoln, NE (US); Brian Beckham, Lincoln, NE (US); Daniel R. Barsell, Omaha, NE (US); Jamie Jesse, Lincoln, NE (US)

(73) Assignee: Lester Electrical of Nebraska, Inc., Lincoln, NE (US)

(21) Appl. No.: 18/388,102

(22) Filed: Nov. 8, 2023

Related U.S. Application Data
(60) Provisional application No. 63/459,812, filed on Apr. 17, 2023.

(51) Int. Cl. B60L 53/22; B60L 53/66; H02J 7/00

(52) U.S. Cl. CPC B60L 53/22; B60L 53/66; H02J 7/0042; B60L 2210/10

(57) ABSTRACT

The present disclosure is a method and apparatus to communicate and convert the electrical power from an EVSE station to a voltage level that an extra low voltage battery on an EV or other similar type of equipment may use to effectively, efficiently, quickly, and safely charge its batteries. The apparatus may be located within or exterior to the electrical equipment which includes extra low voltage batteries. The apparatus may include a power converter and a communication translator. The power converter may be configured to convert electrical power from the EVSE station to a suitable voltage level and current level provided to the extra low voltage batteries. The communication translator may be configured for communicating with the EVSE station and the extra low voltage batteries in order to determine the suitable voltage level and current level to be provided to the extra low voltage batteries.

### CROSS-REFERENCE TO RELATED APPLICATIONS

The present application claims the benefit under 35 U.S.C. § 119(e) of U.S. Provisional Application Ser. No. 63/459,812, filed Apr. 17, 2023, which is incorporated herein by reference in the entirety.

### TECHNICAL FIELD

The present disclosure generally relates to the field of electrical devices; and more particularly to a method and apparatus to charge extra low voltage batteries.

### BACKGROUND

Automotive electric vehicles are typically plugged into a power source, such as a charging station to recharge their batteries. A charging station may include and may be referred as an Electric Vehicle Supply Equipment (EVSE) station or unit. As more and more vehicles are being electrified, EVSE stations are proliferating throughout the world, including direct current (DC) EVSE stations, including those defined as “Mode 4” in IEC 61851, and also referred to as “DC Chargers.” Most batteries for electric vehicles operate at 200 Volts (V) or greater to take advantage of lower power losses associated with a high voltage battery pack allowing lower currents and thus reducing I²R losses. However, other types of electric vehicles exist which may not operate at 200 Volts or greater, and thus, may not be configured to obtain power from EVSE stations.

### SUMMARY

Accordingly, the present disclosure is directed to a method and apparatus to communicate and convert electrical power from a EVSE station to a voltage level that an extra low voltage battery on an EV or other similar type of equipment may use to effectively, efficiently, quickly, and safely charge its batteries. The apparatus may be located within or exterior to the electrical equipment which includes the extra low voltage batteries. The apparatus may include a power converter and a communication translator. The power converter may be configured to adjust input power from the EVSE station to a suitable voltage and current supplied to the extra low voltage batteries and a communication translator may be configured for communicating with the EVSE station and the extra low voltage batteries in order to determine the suitable voltage and current provided by the EVSE station and supplied to the extra low voltage batteries.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are an example and explanatory only and are not necessarily restrictive of the subject matter claimed.

### BRIEF DESCRIPTION OF THE DRAWINGS

The numerous advantages of the disclosure may be better understood by those skilled in the art by reference to the accompanying figures.

FIG. 1 is a block diagram of an apparatus to charge extra low voltage batteries in accordance with one or more embodiments of the present disclosure.

FIG. 2 is a block diagram of an apparatus to charge a plurality of extra low voltage battery packs in accordance with one or more embodiments of the present disclosure.

FIG. 3 is a block diagram of an apparatus to charge extra low voltage batteries configured to be placed within an electrical equipment in accordance with one or more embodiments of the present disclosure.

FIG. 4 is a circuit diagram of an apparatus to charge extra low voltage batteries configured to be placed within an electrical vehicle in accordance with one or more embodiments of the present disclosure.

FIG. 5 is a flow chart representing a method of charging extra low voltage batteries in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “embodiments” means that a particular element, feature, structure, or characteristic described in connection with the embodiment is included in at least one embodiment disclosed herein. The appearances of the phrase “in embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is contemplated that electrical equipment such as vehicles, machines, golf cars, Neighborhood Electric Vehicles (NEVs), Low-Speed Vehicles (LSVs), Personal Transportation Vehicles (PTVs), Utility Vehicles (UTVs), All-Terrain Vehicles (ATVs), outdoor power mowers and equipment, power sports vehicles, industrial vehicles, Mobile Elevated Work Platforms (MEWPs), Material Handling Equipment (MHE), Automated Guided Vehicles (AGVs), Automated Mobile Robots (AMRs), floor machines, motorcycles, construction equipment, or other similar applications may include rechargeable batteries which are capable of being charged quickly. However, the extra low voltage batteries of these types of electrical equipment are not able to connect to the DC operating mode of an EVSE station due to the mismatch of the extra low voltage of the battery pack of the electrical equipment. Rather, the EVSE station is designed specifically to charge the low voltage batteries of full-size electric vehicles, such as electric vehicles manufactured and sold by TESLA. Low voltage batteries are batteries that operate at less than or equal to 1500 Volts.

Conventional electrical equipment with extra low voltage batteries is required to have an on-board charger which can operate on a typical AC supply voltage or be used in conjunction with an AC Mode 1, 2, or 3 (per IEC 61851) or Level 1 or 2 (per SAE J1772) EVSE, and cannot take advantage of a short-time duration or quick charge provided by DC charging. An issue with EVSE stations is that the voltage present is not compatible with the batteries in extra low voltage battery electric equipment and electric vehicles. The higher voltages supplied by an EVSE station, which can typically range from 200 to 1000 Volts or more, will permanently damage these extra low voltage batteries. While this problem can be remedied by not using a EVSE station, it is desirable to allow all electric vehicles and various types of electrical equipment to be able to re-charge to improve transportation or operation capability for all types of electric vehicles and electric equipment. For example, golf cars may be one type of vehicle in which the lower voltage battery packs require re-charging but are not suitable for re-charging at an EVSE station because of the voltage difference.

The apparatus of the present disclosure may operate to allow extra low voltage battery electric equipment to be re-charged at an EVSE station. The apparatus of the present disclosure may be configured to communicate with the EVSE station and may be configured to convert the high voltage of an EVSE station in order to provide a quick and efficient charge to extra low voltage batteries of golf cars, lawn mowers, and the like which operate with extra low voltage batteries. Extra low voltage batteries operate at less than or equal to 120 Volts.

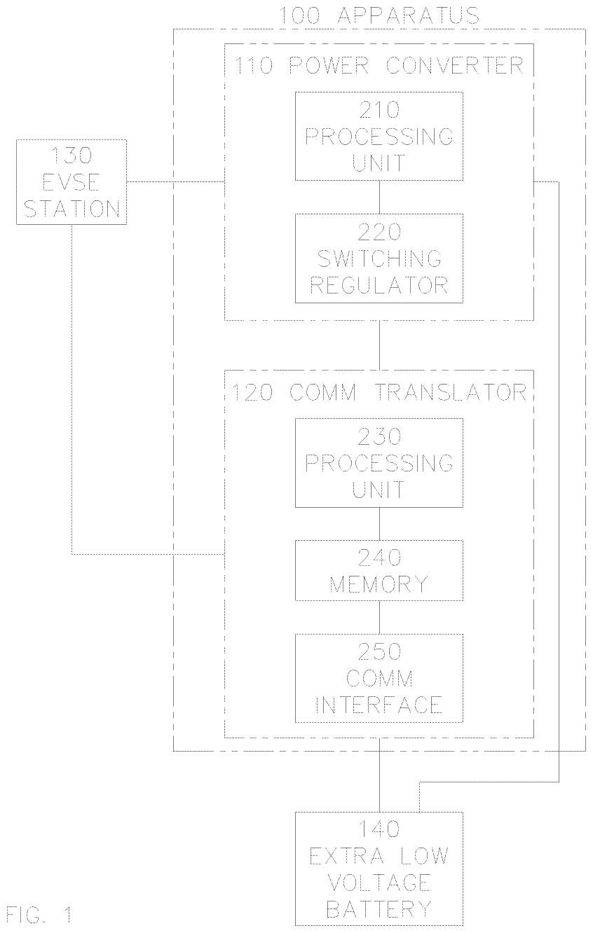

Referring to FIG. 1, a block diagram of an apparatus 100 to charge extra low voltage batteries 140 in accordance with one or more embodiments of the present disclosure is shown. The apparatus 100 may be located within or exterior to electrical equipment which includes extra low voltage batteries. The apparatus 100 may include a power converter 110 and a communication translator 120. The power converter 110 may be configured to adjust input power from the EVSE station 130 to a suitable voltage and current supplied to the extra low voltage batteries 140. The communication translator 120 may be configured for communicating with the EVSE station 130. The communication translator 120 may also be configured for communicating with the extra low voltage batteries 140 in order to determine the suitable voltage and current to be supplied by the EVSE station 130, which may be converted by the power converter 110, and then provided to the extra low voltage batteries 140. It is contemplated that extra low voltage batteries may include a battery management system (BMS). The communication translator 120 may communicate with the BMS of the extra low voltage batteries to determine battery capacity, re-charge requirements, and the proper voltage level and current level to be provided for re-charging.

The EVSE station 130 may be an Electric Vehicle Supply Equipment (EVSE) station with a direct current (DC) supply, including those defined as “Mode 4” in IEC 61851, and also referred to as “DC Chargers.” It is contemplated that extra low voltage (ELV) batteries are defined as batteries that are less than or equal to 120 Volts DC. As shown in FIGS. 1-5, extra low voltage batteries 140 may include a single battery, may include one or more batteries, or may include a battery pack, or the like, in which the single battery or one or more batteries are less than or equal to 120 Volts DC per IEC standard 61140. It is further contemplated that EVSE station 130 may be referred to as a power source or charging station.

Power converter 110 may be a DC/DC switch mode power supply. It is contemplated that the power converter 110 may be constructed using a variety of topologies, including LLC, half bridge, resonant half bridge, full bridge, resonant full bridge, forward, fly-back, or non-isolated buck. Power converter 110 may include a processing unit 210, such as a microprocessor, and may include a switching regulator circuit 220 which may be operated according to commands received from the processing unit 210. It is contemplated that the processing unit 210 may provide commands to the switching regulator circuit 220 in order for the power converter 110 to convert the voltage and current received from the EVSE station 130 into a suitable voltage level and current level to be provided to re-charge the extra low voltage batteries 140.

The communication translator 120 may be configured to detect when apparatus 100 is connected to the EVSE station 130 and then turn on and convert the power from the EVSE station 130 via the power converter 110, typically over several hundred volts, to the voltage level and current level provided to the extra low voltage batteries 140 for re-charging. When the apparatus 100 is disconnected from an electrical port of the EVSE station 130 or the extra low voltage batteries 140, then communication translator 120 may be configured to shut off power to the extra low voltage battery electric equipment to protect the device and user from damage or electrical hazards due to electrocution.

The communication translator 120 may include a processing unit 230, a memory 240, and a communication interface 250. The processing unit 230 may include any processor or processing element known in the art. For the purposes of the present disclosure, the processing unit 230 may be broadly defined to encompass any device having one or more processing or logic elements (e.g., one or more microcontrollers, one or more micro-processor devices, one or more application specific integrated circuit (ASIC) devices, one or more field programmable gate arrays (FPGAs), or one or more digital signal processors (DSPs)). In this sense, the processing unit 230 may include any device configured to execute algorithms and/or instructions (e.g., program instructions stored in the memory 240. It is further contemplated that processing unit 210 of power converter 110 may be similarly defined as processing unit 230.

The memory 240 of the communication translator 120 may include a tangible, computer-readable storage medium that provides storage functionality to store various data and/or program code associated with operation of the processing unit 230, such as software programs and/or code segments, or other data to instruct the processing unit 230 to perform the functionality described herein. It should be noted that while a single memory is described, a wide variety of types and combinations of memory (e.g., tangible, non-transitory memory) can be employed. The memory 240 can be integral with the processing unit 230, can comprise stand-alone memory, or can be a combination of both. Some examples of the memory 240 can include removable and non-removable memory components, such as a programmable logic device, random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

The communication interface 250 of communication translator 120 may be operatively configured to communicate with other components of the apparatus 100, and may communicate with EVSE station 130 and extra low voltage batteries 140. It is contemplated that the communication interface 250 may be configured to retrieve data, transmit data for storage in the memory 240, retrieve data from the memory 240, and so forth. The communication interface 250 may also be communicatively coupled with the processing unit 230, and processing unit 210 of power converter 110, in order to provide commands as to the voltage and current to be supplied by the EVSE station 130 and the conversion of power by the power converter 110 in order to provide a desirable voltage and current supply to the extra low voltage batteries 140.

Communication translator 120 of the apparatus 100 may be configured to use a communication method to communicate with the EVSE station 130 to enable the proper power conversion and communicates with the extra low voltage batteries 140 to allow a safe transfer and conversion of power between the EVSE station 130 and the extra low voltage batteries 140 of electric equipment. The communication translator 120 may be configured to operate with a variety of devices, thus configured to operate as a translator between the extra low voltage batteries 140 and the EVSE station 130. The communication translator 120 and power converter 110 may use proprietary software and hardware to accomplish this task to accomplish compliance using DIN SPEC 70121, ISO/IEC 15118, or other appropriate standards.

In an alternative embodiment, the apparatus 100 to communicate and convert the electrical power from the EVSE station 130 may include standard “off the shelf” software and proprietary hardware to communicate and convert the power from an EVSE station 130 to the extra low voltage batteries 140 of electric equipment. It is contemplated that the apparatus 100 may include a connector device that may include a North American Charging System (NACS), J1772 combo, Combined Charging System Combo 1 (CCS1), Combined Charging System Combo 2 (CCS2), or similar style connector between the EVSE station 130 and the extra low voltage batteries 140. However, it is contemplated that any type of connector, including, but not limited to proprietary types may also be used. The extra low voltage batteries 140 may operate on different nominal battery voltages, such as voltages of less than 120 Volts, such as 24V, 36V, 48V, 72V, 96V, and the like, without departing from the scope and intent of the present disclosure.

The communication translator 120 may be configured to communicate in a variety of formats, including controller area network bus (CAN bus), power-line carrier communication (PLCC), or any other serial communication. It is further contemplated that the communication interface 250 of communication translator 120 may include a BLUETOOTH transceiver, WIFI transceiver, and hardwire connector such as USB. It is further contemplated that communication translator 120 may be configured to store a data identifier which may include the identity of the user, and may include payment information for use when using an EVSE station 130. The data identifier may be uploaded via a mobile application or hardwire delivery and stored within the memory 240 of the communication translator 120. It is further contemplated that apparatus 100 may include a battery management application that may be accessed by a user in order to track and maintain battery usage and re-charge activity.

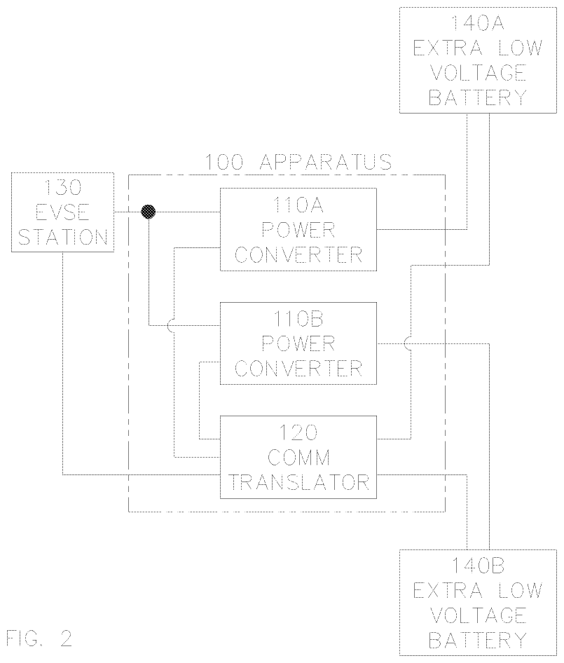

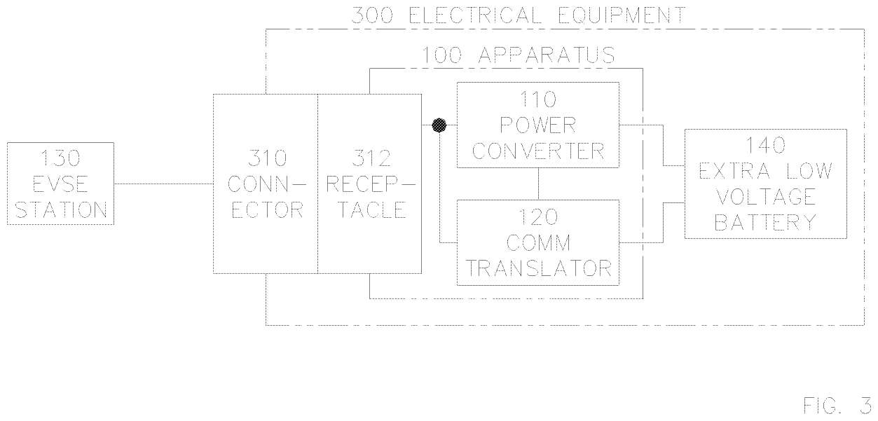

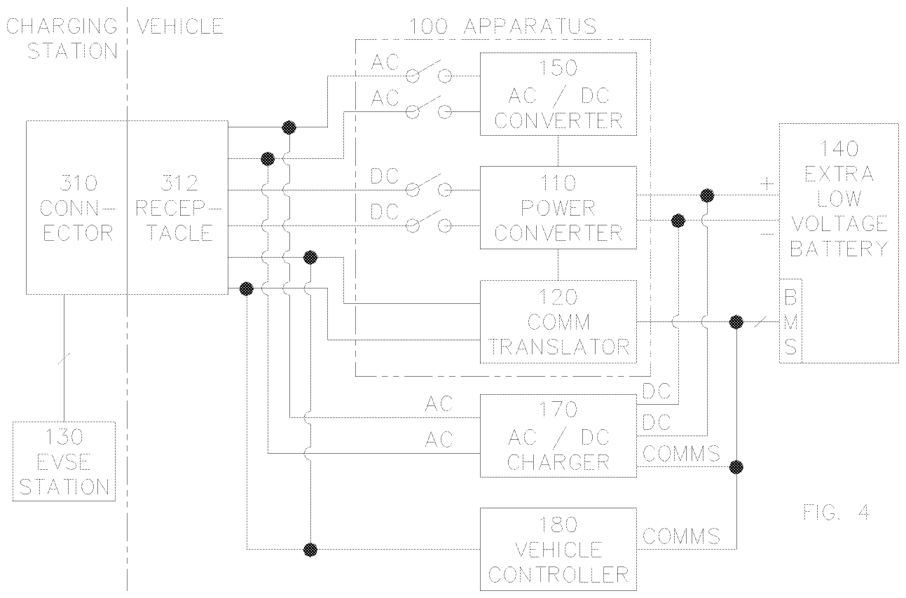

Referring to FIG. 2, a block diagram of an apparatus 100 to charge a plurality of extra low voltage battery packs 140A, 140B in accordance with one or more embodiments of the present disclosure is shown. As shown in FIG. 2, apparatus may be employed to charge multiple pieces of electrical equipment, such as two lawn mowers which may operate on extra low voltage batteries 140A, 140B. Apparatus 100 may include a power converter 110A which may provide a voltage and current to re-charge extra low voltage batteries 140A and may include a power converter 110B to re-charge extra low voltage batteries 140B. It is contemplated that power converter 110A, 110B may be similar to power converter 110 as described with respect to FIG. 1, and may each include a processing unit 210 and switching regulator circuit 220. It is contemplated that a single communication translator 120, or multiple communication translators, may be employed to communicate with EVSE station 130 and each extra low voltage batteries 140A, 140B. Communication translator 120 as shown in FIG. 2, along with FIGS. 3-4, may be similarly defined as described with respect to FIG. 1.

Referring to FIG. 3, a block diagram of an apparatus 100 to charge extra low voltage batteries configured to be placed within a piece of electrical equipment 300, such as an electrical vehicle in accordance with one or more embodiments of the present disclosure is shown. Electrical equipment 300 may include a connector assembly 310, 312 which may allow a connector 310 from the EVSE station 130 to be connected with a receptacle 312 which may be formed on and/or within the electrical equipment 300, and further connected to the apparatus 100. It is contemplated that the connector assembly 310, 312, and in one embodiment the receptacle of the apparatus 100, may be in conformity with standards for re-charging electric vehicles, such as NACS, J1772 combo, CCS1, or CCS2.

Referring to FIG. 4, a circuit diagram of an apparatus 100 to charge extra low voltage batteries 140 configured to be placed within a piece of electrical equipment, such as an electric vehicle, in accordance with one or more embodiments of the present disclosure is shown. It is contemplated that apparatus 100 may further include an AC/DC converter 150 which may allow for AC charging. While an electric vehicle may include an AC/DC charger 170, it is contemplated that through use of the apparatus 100 as shown in FIG. 4, such AC/DC charger 170 may be not be required for the electric vehicle and may reduce the componentry and weight of an electric vehicle.

As shown in FIG. 4, communication translator 120 may be configured to communicate with the EVSE station 130, a battery management system of extra low voltage battery 140, an AC/DC charger 170 that may be present within an electric vehicle, and a vehicle controller 180, such as an electric vehicle communication controller (EVCC). In an embodiment of the disclosure, the communication translator 120 may communicate with the vehicle controller 180 and AC/DC charger 170 via a controller area network bus, referred as CAN Bus or other similar communication scheme.

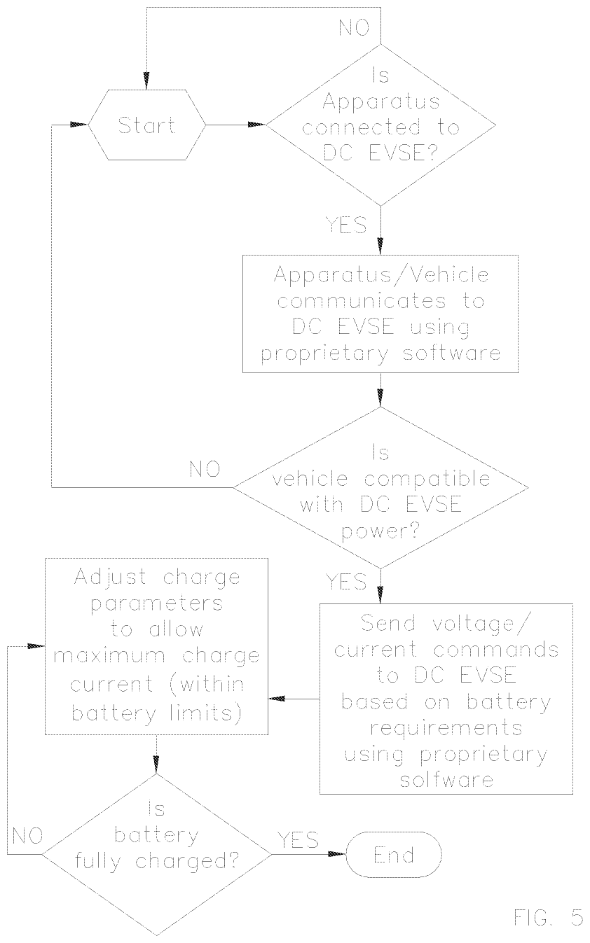

Referring to FIG. 5, a flow chart representing a method of charging extra low voltage batteries in accordance with one or more embodiments of the present disclosure is shown. The method of charging extra low voltage battery electric equipment from an EVSE station employing the apparatus 100 as shown in FIGS. 1-4. It is contemplated that the method may begin with a connection between the extra low voltage battery electric equipment and the EVSE station. When a connection is established, the extra low voltage battery electric equipment may communicate with the EVSE station via the apparatus 100 of the present disclosure as shown in FIGS. 1-4. If the extra low voltage battery electric equipment may be re-charged by the EVSE station, then the apparatus 100 may communicate the voltage and current commands in order to allow proper charging of the extra low voltage battery electric equipment. It is contemplated that the commands may be in a form of proprietary software. The parameters of the charge may be adjusted in order to provide the largest current charge within battery limits for the extra low voltage battery electric equipment. The process may continue until one or more batteries of the extra low voltage battery electric equipment may be fully charged.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

It is believed that the present disclosure and many of its attendant advantages will be understood by the foregoing description, and it will be apparent that various changes may be made in the form, construction, and arrangement of the components without departing from the disclosed subject matter or without sacrificing all its material advantages. The form described is merely explanatory, and it is the intention of the following claims to encompass and include such changes.

What is claimed is:

1. An apparatus for charging an extra low voltage battery, comprising:
a power converter, the power converter configured to receive electrical power from a power source and convert the electrical power received from the power source to a voltage level and current level to charge the extra low voltage battery; and
a communication translator, the communication translator configured to communicate with the power source and the extra low voltage battery, the communication translator configured to adjust the electrical power received from the power source and provide instructions to the power converter to convert the electrical power from the power source to the voltage level and the current level to charge the extra low voltage battery.

2. The apparatus as claimed in claim 1, wherein the apparatus is configured to be located within electrical equipment in which the extra low voltage battery is contained.

3. The apparatus as claimed in claim 1, wherein the apparatus is configured to be external to the electrical equipment in which the extra low voltage battery is contained.

4. The apparatus as claimed in claim 1, wherein the power converter is a DC/DC switch mode power supply.

5. The apparatus as claimed in claim 4, wherein the power converter is constructed by at least one of the following topologies: LLC, Half bridge, Resonant half bridge, Full bridge, Resonant full bridge, Forward, Fly-back, or Non-isolated Buck.

6. The apparatus as claimed in claim 1, wherein the communication translator is configured to detect a connection with the power source.

7. The apparatus as claimed in claim 1, wherein the power source is an Electric Vehicle Supply Equipment (EVSE) station.

8. The apparatus as claimed in claim 7, wherein the apparatus includes a receptacle configured to connect with a connector, the connector is connected with the EVSE station.

9. The apparatus as claimed in claim 8, wherein the receptacle of the apparatus is in conformity with one or more standards: NACS, J1772 combo, CCS1, or CCS2.

10. The apparatus as claimed in claim 1, wherein the power source provides the electrical power, the electrical power having a voltage greater than or equal to 200 Volts.

11. The apparatus as claimed in claim 10, wherein the voltage level provided by the power converter to the extra low voltage battery is less than or equal to 120 Volts.

12. An apparatus for charging an extra low voltage battery, comprising:
a power converter, the power converter including a DC/DC switch mode power supply, the power converter configured to receive electrical power from a power source and convert the electrical power received from the power source to a voltage level and current level to charge the extra low voltage battery; and
a communication translator, the communication translator configured to communicate with the power source and the extra low voltage battery, the communication translator configured to adjust the electrical power received from the power source and provide instructions to the power converter to convert the electrical power from the power source to the voltage level and the current level to charge the extra low voltage battery, wherein the electrical power from the power source having a voltage greater than or equal to 200 Volts and the voltage level provided by the power converter to the extra low voltage battery is less than or equal to 120 Volts.

13. The apparatus as claimed in claim 12, wherein the apparatus is configured to be located within electrical equipment in which the extra low voltage battery is contained.

14. The apparatus as claimed in claim 12, wherein the apparatus is configured to be external to the electrical equipment in which the extra low voltage battery is contained.

15. The apparatus as claimed in claim 12, wherein the power converter is constructed by at least one of the following or similar topologies: LLC, Half bridge, Resonant half bridge, Full bridge, Resonant full bridge, Forward, Fly-back, or Non-isolated Buck.

16. The apparatus as claimed in claim 12, wherein the communication translator is configured to detect a connection with the power source.

17. The apparatus as claimed in claim 12, wherein the power source is an Electric Vehicle Supply Equipment (EVSE) station.

18. The apparatus as claimed in claim 17, wherein the apparatus includes a receptacle configured to connect with a connector, the connector is connected with the EVSE station.

19. The apparatus as claimed in claim 18, wherein the receptacle of the apparatus is in conformity with one or more standards: NACS, J1772 combo, CCS1, or CCS2.

20. An apparatus for charging an extra low voltage battery, comprising:
a power converter, the power converter including a DC/DC switch mode power supply, the power converter configured to receive electrical power from a power source and convert the electrical power received from the power source to a voltage level and current level to charge the extra low voltage battery; and
a communication translator, the communication translator including a processing unit, a memory, and a communication interface, the processing unit of the communication translator configured to execute a program of instructions stored in the memory, that when executed by the processing unit, cause the processing unit to:
communicate with the power source and the extra low voltage battery; adjust the electrical power received from the power source; and provide instructions to the power converter to convert the electrical power from the power source to the voltage level and the current level to charge the extra low voltage battery, wherein the electrical power from the power source having a voltage greater than or equal to 200 Volts and the voltage level provided by the power converter to the extra low voltage battery is less than or equal to 120 Volts.
